(19) United States
(12) Patent Application Publication
(10) Pub. No.: US 2026/0330094 A1
(43) Pub. Date: Oct. 22, 2026

(54) SYSTEMS AND METHODS FOR SIMULATION OF LASER FLUENCE ON A SURFACE OF A PART DURING A LASER TREATMENT PROCESS

(71) Applicant: IPG PHOTONICS CORPORATION, Marlborough, MA (US)

(72) Inventors: Thomas M. Bjorlin, Carrollton, TX (US); Ramiro M. Garcia, Davenport, IA (US); Donald R. Miehe, Long Grove, IA (US); Dmitri NOVIKOV, Avon, CT (US); Carlos LAGOS, Bettendorf, IA (US)

(21) Appl. No.: 19/698,096

(22) Filed: Jun. 4, 2026

Related U.S. Application Data
(63) Continuation of application No. PCT/US2024/058458, filed on Dec. 4, 2024.
(60) Provisional application No. 63/605,872, filed on Dec. 4, 2023.

(51) Int. Cl. G06F 30/20

(52) U.S. Cl. CPC G06F 30/20

(57) ABSTRACT

Systems and methods for simulation of laser fluence simulate a laser treatment process to be performed on a part by a laser processing system and determine simulated fluence values at points on a surface of the part to be processed. The simulated fluence value is determined at each point on the surface of the part to be processed by virtually measuring a ray distance to each point and ray angle at each point during a simulation of the laser treatment process. The ray distances and ray angles are virtually measured based on a ray origin associated with an optics component used to deliver the laser to the surface. The optics component may include a scanning optics component that scans the laser beam on the surface or a projection optics component that projects the laser beam on the surface. The simulated fluence values determined by the simulation may be used to optimize the actual laser treatment process.

### CROSS-REFERENCE TO RELATED APPLICATION

The present application is a continuation of PCT Application No. PCT/US2024/058458 filed Dec. 4, 2024, which claims the benefit of U.S. Provisional Patent Application Ser. No. 63/605,872 filed Dec. 4, 2023, both of which are fully incorporated herein by reference.

### TECHNICAL FIELD

The present disclosure relates to laser processing and more particularly, to systems and methods for simulation of laser fluence on a surface of a part during a laser treatment process being performed on the part.

### BACKGROUND

Lasers have been used to treat surfaces, for example, using laser ablation and laser heating. Laser ablation uses a laser to ablate and remove material from the surface of a part and laser heating uses a laser to heat a surface of the part. Laser ablation examples include cleaning, texturing, machining, paint removal, thin film patterning, blind-hole and shaped feature drilling, localized conformal coating removal, etc. Laser heating may be used to heat material on the surface of a part, for example, for drying a surface, curing of paint or other curable material on a surface, and hardening of a surface.

Laser treatment of a surface often requires a certain laser energy on the surface to be effective. Laser treatment processes are often performed on parts with irregular and complex shapes and the laser energy on the surface of the part often varies due to varying part geometry and movement of the laser relative to the part. One challenge with such laser treatment processes is obtaining the desired laser energy at the various locations on the surface of such irregular parts during the laser treatment process.

### SUMMARY

Consistent with an aspect of the disclosure, a computer-implemented method is provided for simulation of laser fluence on a part to be processed during a laser treatment process performed by a laser processing system including a laser and an optics component. The computer-implemented method includes receiving, by one or more computer processors, at least part data and laser processing parameters. The part data represents the part to be processed during the laser treatment process, and the laser processing parameters define characteristics of the laser treatment process and the laser processing system. The computer-implemented method also includes virtually measuring, by one or more computer processors, ray distances to a plurality of points on a surface of the part to be processed and ray angles relative to the plurality of points on the surface of the part to be processed during a simulation of the laser treatment process. The ray distances and the ray angles are based on a ray origin determined relative to the optics component. The computer-implemented method further includes determining, by the one or more computer processors, a simulated fluence value for each point of the plurality of points on the surface of the part to be processed. The simulated fluence value is determined from the ray distance and the ray angle virtually measured for each point during the simulation of the laser treatment process and from the laser processing parameters.

Consistent with another aspect of the disclosure, a non-transitory computer readable storage medium comprising computer readable instructions which when executed by a processor, causes the processor to perform the operations of a method for simulation of laser fluence. The operations include receiving at least part data and laser processing parameters. The part data represents a part to be processed during a laser treatment process using a laser processing system including a laser and an optics component. The laser processing parameters define characteristics of the laser treatment process and the laser processing system. The operations also include virtually measuring ray distances to a plurality of points on a surface of the part to be processed and ray angles relative to the plurality of points on the surface of the part to be processed during a simulation of the laser treatment process. The ray distances and the ray angles are based on a ray origin determined relative to the optics component. The operations further include determining a simulated fluence value for each point of the plurality of points on the surface of the part to be processed. The simulated fluence value is determined from the ray distance and the ray angle virtually measured for each point during the simulation of the laser treatment process and from the laser processing parameters.

### BRIEF DESCRIPTION OF THE DRAWINGS

Reference should be made to the following detailed description which should be read in conjunction with the following figures, wherein like numerals represent like parts.

FIG. 1 is a functional block diagram illustrating a system for simulation of laser treatment of a surface, consistent with embodiments of the present disclosure.

FIG. 2 is a functional block diagram of a scanning laser processing system that uses a laser scanner suitable for laser treatment of a surface, consistent with an embodiment of the present disclosure.

FIG. 2A is perspective view of a laser scanner coupled to a robotic arm in a scanning laser processing system, consistent with an embodiment of the present disclosure.

FIG. 2B is a perspective view of a laser scanner in a scanning laser processing system of FIG. 2A performing a laser ablation process, consistent with an embodiment of the present disclosure.

FIG. 3 is a screenshot illustrating a 3D model of a laser scanner configuration with rays extending from a ray origin to a field of view of the laser scanner, consistent with an embodiment of the present disclosure.

FIG. 3A illustrates calculation of a ray origin location relative to the laser scanner shown in FIG. 3.

FIG. 4 is a screenshot of an example graphical user interface (GUI) showing a 3D image of a part with colors representing a simulation of laser fluence on a surface of the part, consistent with an embodiment of the present disclosure.

FIG. 5 is a table illustrating an example of relative fluence as a function of defocus distance and glancing angle in a scanning laser processing system, consistent with an embodiment of the present disclosure.

FIG. 6 is a screenshot of an example GUI displaying results of a laser fluence simulation to a user including a laser fluence quality report, consistent with an embodiment of the present disclosure.

FIGS. 7A and 7B are screenshots of an example GUI for selecting and/or entering laser processing parameters for a laser fluence simulation in a scanning laser processing system, consistent with an embodiment of the present disclosure.

FIG. 7C is a top view of a laser scanner illustrating a laser direction parameter, consistent with an embodiment of the present disclosure.

FIG. 7D is a screenshot of an example GUI for selecting and/or entering simulation parameters for a laser fluence simulation in a scanning laser processing system, consistent with an embodiment of the present disclosure.

FIG. 7E is a screenshot of an example GUI displaying results of a laser fluence simulation including a histogram chart that may be configured using simulation parameters in FIG. 7D, consistent with an embodiment of the present disclosure.

FIG. 8 is a perspective view of a projection laser processing system, consistent with another embodiment of the present disclosure.

FIG. 8A is a perspective view of a laser projection head in the projection laser processing system of FIG. 8 performing a heating process, consistent with another embodiment of the present disclosure.

FIG. 9A is a screenshot of an example GUI for selecting and/or entering laser processing parameters for a laser fluence simulation in a projection laser processing system, consistent with another embodiment of the present disclosure.

FIG. 9B is a top view of a projection laser processing system illustrating projection field size parameters in the X and Y direction, consistent with another embodiment of the present disclosure.

FIG. 9C is a screenshot of an example GUI for selecting and/or entering simulation parameters for a laser fluence simulation in a projection laser processing system, consistent with another embodiment of the present disclosure.

FIG. 10 is a flow chart diagram depicting operations for a method for simulation of laser fluence on a part to be processed with a laser treatment process, consistent with embodiments of the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

Systems and methods for simulation of laser fluence, consistent with embodiments of the present disclosure, simulate a laser treatment process to be performed on a part by a laser processing system and determine simulated fluence values at points on a surface of the part to be processed. The laser processing system generally includes a laser for generating a laser beam and an optics component for delivering the laser beam to the surface of the part during the laser treatment process. The simulated fluence value is determined at each point on the surface of the part to be processed by virtually measuring a ray distance to each point and ray angle at each point during a simulation of the laser treatment process. The ray distances and ray angles are virtually measured based on a ray origin associated with the optics component used to deliver the laser to the surface. The optics component may include a scanning optics component that scans the laser beam on the surface or a projection optics component that projects the laser beam on the surface.

The simulated fluence values determined by the simulation may be displayed to the user (e.g., using colors on an image of the part to be processed) to allow the user to optimize the actual laser treatment process and/or may be used directly by the laser processing system to optimize the actual laser treatment process. The laser treatment process may include any process where laser energy is provided on a surface of the part, for example, to alter a material by ablation or heating including, without limitation, cleaning, drying, curing and hardening the surface of the part.

As used herein, “laser fluence” or “fluence” refers to the amount of energy per unit area and is also known as energy density. As used herein, “nominal fluence” refers to the laser fluence that has been predetermined for a laser treatment process using a particular laser processing system. As used herein, “simulated fluence value” refers to any value representing fluence (e.g., expressed as J/cm²) on the surface or representing relative fluence in comparison to nominal fluence (e.g., expressed as a percentage of nominal fluence) on the surface. As used herein, “ray angle” refers to either an angle of incidence or a glancing angle relative to the surface, which are related as 90° complements. As used herein, “laser processing parameters” include any parameters defining aspects of the laser treatment process and/or components in the laser processing system (e.g., the laser and/or optics component).

According to a laser treatment process, a laser processing system may be programmed (in either a static position or in a motion path) for a particular part to be processed prior to starting the laser treatment process. Physical trials may be required to prove out and optimize the laser treatment process, which may involve many parts for the trials and a significant amount of time to run the trials on a physical system. This incurs costs for the trial parts as well as down time for the laser processing system. Systems and methods for simulation of laser fluence on a part to be processed, consistent with the embodiments of the present disclosure, may allow optimization of the laser treatment process without the need for trial parts or a physical system, thereby reducing or eliminating the waste of trial parts and the system downtime.

Systems and methods for simulation of laser fluence, as disclosed herein, operate on the principle that laser fluence on the surface of the part changes as a function of change in the distance that the laser beam travels to the surface and change in the angle of the laser beam relative to the surface. With a scanning optics component using a focused beam, changes in the distance from the scanning optics to the surface may result in defocus and an increased laser beam spot size due to defocus and increases in the angle of incidence of the laser beam on the part surface may further result in an increase in the beam spot area. Beam spot area and laser fluence are inversely proportional, and an increase in the beam spot area as a result of the changing distance and angle of incidence at a particular point on the surface results in a decrease in the laser fluence at that point on the surface. With a projection optics component, changes in the distance and angle of incidence of the laser beam relative to the surface result in a change in the illumination on the surface. The illumination decreases with increases in the distance and/or increases in the angle of incidence at a particular point on the surface, which results in a decrease in the laser fluence at that point on the surface.

Surface treatment processes may require certain nominal fluence levels to be most effective depending on the surface conditions. Fluence variations occur due to varying part geometry and the relative position and orientation of the optics component with respect to the part (e.g., with a robot mounted optics component that is moved around the part). Using a simulation to determine simulated fluence values before performing the surface treatment process for a particular part having a varying geometry assists the user when programming the surface treatment process for the part.

Systems and methods for simulation of laser fluence, consistent with embodiments disclosed herein, may be used during simulation and off-line programming of a laser treatment process. Existing simulation and offline programming software may be used to create a simulation program for a laser treatment process to be performed by a laser processing system. One example of such simulation software includes the 3D simulation software for manufacturing available from Visual Components. The Visual Components 3D simulation software includes an Application Programming Interface (API) to provide the ability to create custom programs to control component behavior. In an embodiment, a system and method for simulation of laser fluence may be implemented as a custom program to create a behavior for the laser processing system that uses an API module to simulate the laser treatment process on a part. The Visual Components 3D simulation software includes a RayCast function that may be used to virtually measure the ray distances and ray angles used to determine the simulated fluence values. The simulation may show the area affected by the laser which may be colored according to the simulated fluence values at each point on the surface. In other embodiments, a system and method for simulation of laser fluence may be implemented independently of existing simulation and offline programming software.

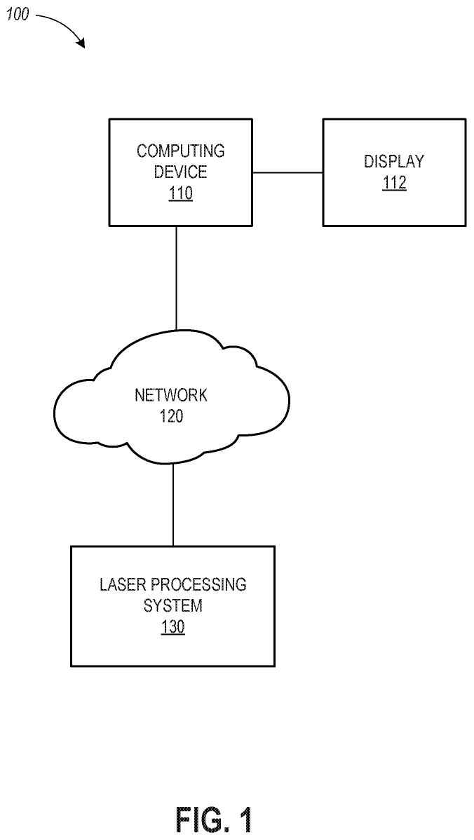

FIG. 1 is a functional block diagram illustrating a system 100 for simulation of laser fluence on a surface of a part, consistent with the present disclosure. FIG. 1 provides only an illustration of one implementation and does not imply any limitations with regard to the environments in which different embodiments may be implemented. Many modifications to the depicted environment may be made by those skilled in the art without departing from the scope of the disclosure as recited by the claims.

The system 100 includes a computing device 110 optionally connected to a network 120. The network 120 can be, for example, a telecommunications network, a local area network (LAN), a wide area network (WAN), such as the Internet, or a combination of the three, and can include wired, wireless, or fiber optic connections. The network 120 can include one or more wired and/or wireless networks that are capable of receiving and transmitting data, voice, and/or video signals, including multimedia signals that include voice, data, and video information. In general, the network 120 can be any combination of connections and protocols that will support communications between the computing device 110 and other computing devices (not shown) within the system 100.

The computing device 110 can be a standalone computing device, a management server, a web server, a personal computer, a laptop computer, or any programmable electronic device including one or more processors capable of executing program instructions for laser processing within the system 100. In another embodiment, the computing device 110 can represent a server computing system utilizing multiple computers as a server system, such as in a cloud computing environment. In yet another embodiment, the computing device 110 represents a computing system utilizing clustered computers and components (e.g., database server computers, application server computers) that act as a single pool of seamless resources when accessed within the system 100. In an embodiment, the computing device 110 includes or is coupled with a display 112.

The system 100 may include a laser processing system 130, optionally connected to the network 120. The laser processing system 130 generally includes a laser for generating a processing laser beam and an optics component for delivering the laser beam to the part to be processed. The type of laser and optics component may depend on the type of laser treatment process. In an embodiment, the laser processing system 130 may be a scanning laser processing system including a scanning optics component (e.g., laser scanner) that scans a focused laser beam on the workpiece, for example, to perform an ablation laser treatment process such as cleaning. In another embodiment, the laser processing system 130 may be a projection laser processing system including a projection optics component that projects a laser beam on the workpiece, for example, to perform a heating laser treatment process such as drying, curing or hardening. Examples of the laser processing systems and optics components are described in greater detail below.

In an embodiment, the user may transfer a program for the laser treatment process to the laser processing system 130 over the network 120. In another embodiment, the user may transfer the program for the laser treatment process to the laser processing system 130 using any other appropriate method as would be known to a person of skill in the art, such as a Universal Serial Bus (USB) memory stick.

The simulation software including the system for simulating laser fluence may be implemented on the computing device 110 coupled to the laser processing system 130, although other embodiments may use a separate stand-alone computing device to implement the simulation software including the system for simulating laser fluence. The computing device 110 receives part data representing the part to be processed (e.g., CAD data) and laser processing parameters defining characteristics of the laser processing system (e.g., the optics component and laser) and/or characteristics of the laser treatment process. Laser processing parameters may include, for example, parameters defining characteristics of the optics component, such as working distance and field of view size, and/or parameters defining characteristics of the laser, such as beam spot size, as will be described in greater detail below. Laser processing parameters may also include parameters defining the laser treatment process, for example, a laser treatment parameter defining a laser treatment patch where the laser treatment process occurs on the surface and a laser path parameter defining a path of the laser beam and/or optics component relative to the part.

The computing device 110 may also receive simulation parameters defining characteristics of the simulation. Simulation parameters may include, for example, parameters defining how the simulation results are displayed to the user and/or used by a laser processing system, as will be described in greater detail below. The computing device 110 executes the simulation software to perform the virtual measurements of the ray distances and ray angles relative to the part represented by the part data and performs calculations of the simulated fluence values using the virtually measured ray distances and ray angles and the laser processing parameters, as will be described in greater detail below.

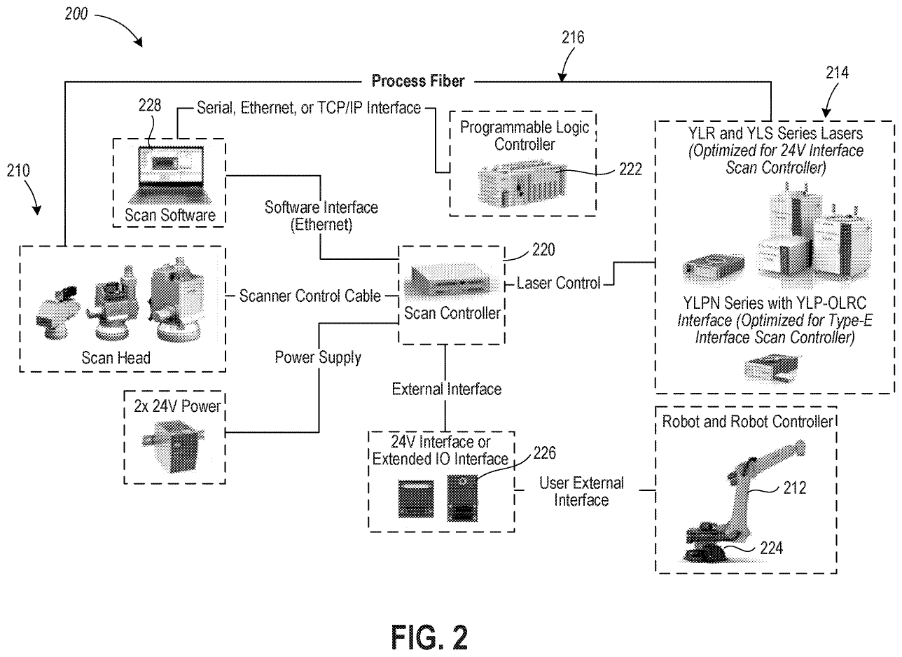

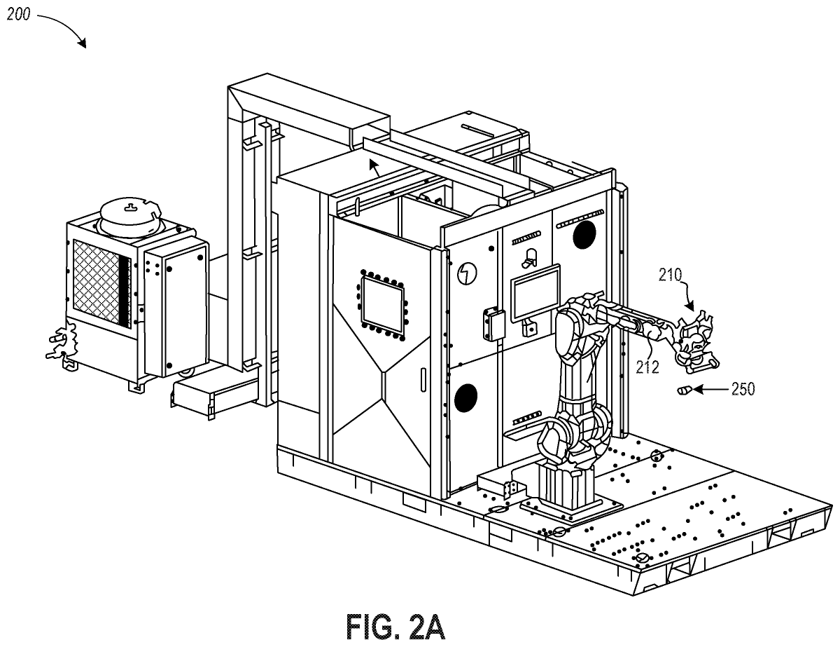

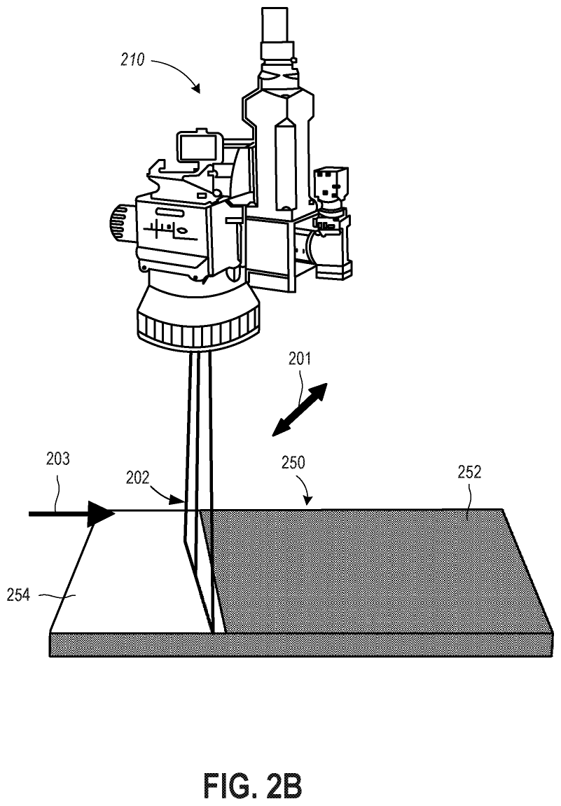

Referring to FIGS. 2-7E, an embodiment of laser fluence simulation for a scanning laser processing system 200 and ablation/cleaning process is described in greater detail. Although some of the examples described herein involve laser ablation primarily for cleaning purposes, the disclosed system and method for simulating laser fluence may also be used in other laser ablation applications including, but not limited to, texturing, machining, paint removal, thin film patterning, blind-hole and shaped feature drilling, localized conformal coating removal, and combinations thereof.

FIGS. 2, 2A and 2B show one example of a scanning laser processing system 200 for performing a laser treatment process, such as an ablation/cleaning process, consistent with an embodiment of the present disclosure. FIG. 2 is a functional block diagram of the laser processing system 200. As shown, the scanning laser processing system 200 includes a scanning optics component 210, a robot arm 212, and a laser 214. The scanning optics component 210 receives laser light from the laser 214 over a fiber 216 and delivers a processing laser beam by focusing and scanning the laser beam. In this example, the laser processing system 200 is controlled by a scan controller 220, a programmable logic controller (PLC) 222, a robot controller 224 and a computer 228 running scan software. The scan controller 224 interfaces with the robot arm 212 via an I/O interface 226. The computer 228 running scan software, PLC 222 and robot controller 224 may work together to execute programs that reside on each device in a coordinated manner to execute the laser treatment process. The computer 228 may also run the simulation software for performing the laser fluence simulation.

The scanning optics component 210 may include a 2-dimensional (2D) mid-power or high-power scanner such as the D20 and D33 laser scan heads available from IPG Photonics Corp. The scanning optics component 210 may include actuators, such as galvo mirrors, for moving the laser beam with respect to a field of view of the scanning optics component 210. The laser 214 may include high power fiber lasers, such as the YLR and YLS Series Lasers available from IPG Photonics Corp.

As shown in FIG. 2A, the scanning optics component 210 is coupled to the robotic arm 212 for movement relative to a part 250 for performing the laser treatment process on the part 250. The robotic arm 212 may move the scanning optics component 210 relative to the part 250 while the scanning optics component 210 scans the laser beam within the field of view of the scanning optics component 210. As shown in FIG. 2B, for example, the scanning optics component 210 may scan the laser beam 202 across a surface 254 of the part 250 in a scan direction indicated by arrow 201 while the scanning optics component 210 moves relative to the part 250 in a cleaning direction indicated by arrow 203. The part 250 has a layer of contamination 252 such as, for example, rust, dust, and/or oil, and the scanning laser beam 202 removes the contamination 252, for example, by ablation. FIG. 2B shows what is known as a “Process-to-Part” configuration in which the robotic arm 212 takes the process to the part 250, which is static or on a coordinated positioner. Alternatively, a “Part-to-Process” configuration may be used in which a robotic arm grips the part and presents the part 250 to a static stand-mounted scanner. Either configuration may be simulated as described herein.

In a laser cleaning application, thousands of focused laser pulses per second may be used to break down and remove contaminants or parent material from the surface. The laser light breaks down the chemical bond, allowing it to safely and effectively remove rust, oil, mold, and other contaminants. Laser cleaning is a proven method for surface cleaning and preparation, coating removal, and surface roughness modification for manufacturing, refurbishment, and repair applications. Laser cleaning is fast, repeatable, and eliminates the need for abrasive grits and chemicals, and reduces solid waste.

Although FIG. 2B shows a flat surface 254 on the part 250, a part 250 often has a more complex surface with a varying geometry. As mentioned above, the laser fluence on such a surface varies at different locations of the surface as a function of the distance the scanning laser beam 202 travels to the surface 254 and the angle of the scanning laser beam 202 relative to the surface 254. Such a variation in laser fluence from a nominal laser fluence for the cleaning process may result in ineffective laser cleaning at certain locations on the surface of the part 250. A simulation of laser fluence on the surface may be used to determine adjustments in the scanning laser treatment process to optimize or provide a more effective laser ablation/cleaning.

According to a method for simulation of laser fluence on a surface of a part to be processed using the scanning laser processing system 200, the computer 228 running the scan software may also run the simulation software and perform the simulation. Alternatively or additionally, the simulation software may be run on a different computer that is not connected to the scanning laser processing system 200. Before running the simulation, the simulation software receives part data, such as Computer Aided Design (CAD) file, representing the part 250 to be cleaned by ablation. The simulation software also receives laser processing parameters defining characteristics of the laser 214 and scanning optics component 210, such as the beam spot shape, beam spot size, beam product parameter, working distance, and scanner field of view dimensions. The simulation software further receives laser processing system parameters defining characteristics of the laser ablation/cleaning process, such as the size of a rectangular ablation patch and/or a path for scanning the laser over the part. The simulation software may further receive simulation parameters that define characteristics of the simulation of laser fluence, such as user-defined thresholds for different ranges of relative fluence. Examples of the laser processing parameters and simulation parameters are described in greater detail below. The simulation software may then run a simulation of the ablation/cleaning process on the part represented by the part data, and during the simulation, performs virtual measurements and determines simulated fluence values for multiple points on the part surface.

The simulation software performs the virtual measurements of ray distance and ray angle using rays extending to the points on the surface from a ray origin that is set relative to the scanning optics component, as will be described in greater detail below. The simulation software compares the ray distance to a nominal distance of the scanner to determine a defocus distance of the laser relative to the surface. The nominal distance of the scanner may be based on the working distance where the laser beam is focused by the scanning optics component. A defocused spot size is then determined from the defocus distance. The simulation software uses the ray angle and the defocused spot size to determine a beam spot area at the point on the surface. The simulation software may then determine a simulated fluence value from the beam spot area at the point on the surface. The simulation software may repeat these virtual measurements and determinations for each of the points on the surface as the ray is scanned across the surface (e.g., within the ablation patch) during the simulation.

The simulated fluence value may be calculated as fluence, such as pulse fluence, or relative fluence, such as a percentage of a nominal fluence. In a scanning laser processing system, pulse fluence (Fₚ) may be calculated by dividing the pulse energy (Eₚ) of the laser by the beam spot area (A), which is the area of the laser beam spot formed by the laser on the surface of the part. As mentioned above, the beam spot area (A) may vary as the beam is scanned on the surface as a function of changing defocus and angle of incidence of the beam. More specifically, the beam spot area (A) increases as defocus and angle of incidence increases and thus pulse fluence (Fₚ) decreases as defocus increases and angle of incidence increases. As mentioned above, the decrease in pulse fluence as a result of scanning the laser across a complex, varying surface of a part may result in less than optimal laser fluence at certain locations on the surface of the part.

The relative fluence may be determined by calculating the pulse fluence at the point and then comparing to a nominal pulse fluence for the laser treatment process. The relative fluence may also be determined by comparing the beam spot area calculated for the point on the surface to a nominal beam spot area for a laser normal to the surface and focused on the surface. Examples of calculations of pulse fluence and relative fluence are described in greater detail below.

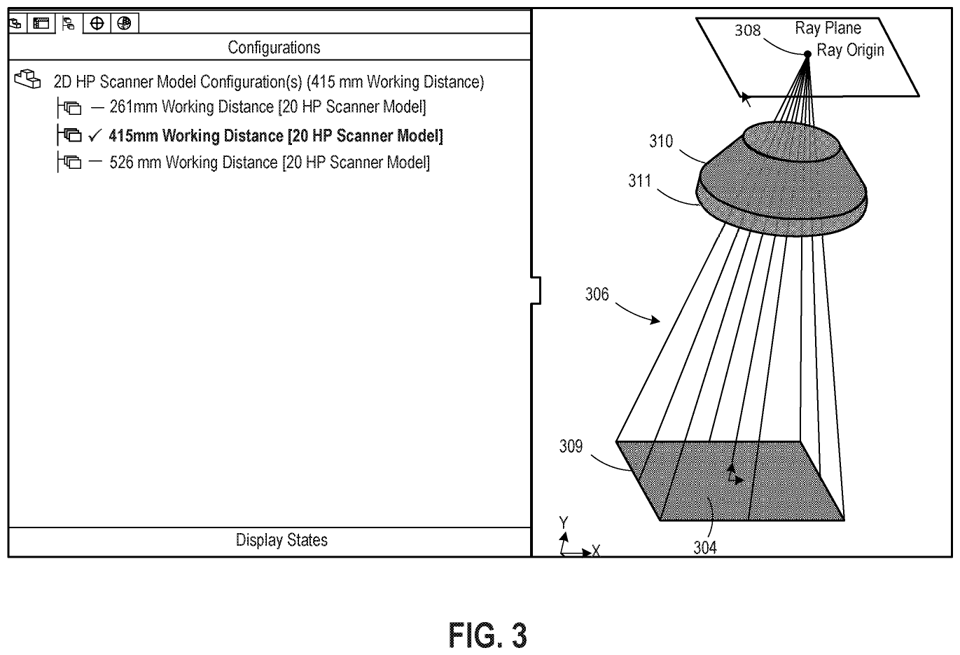

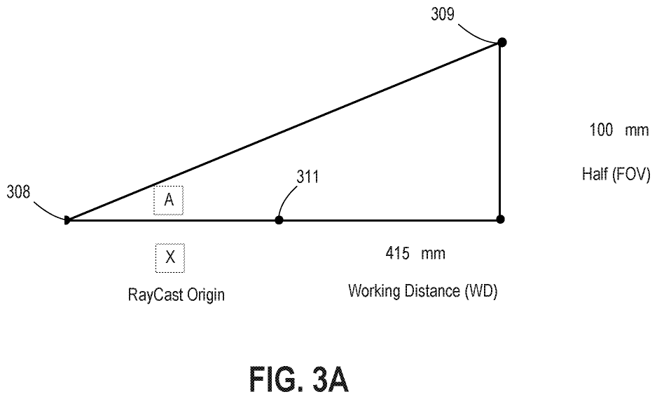

Referring to FIG. 3, the ray measurements for a scanning optics component 310 with a field of view 304 are described in greater detail. In this example, the scanning optics component is a 2D high power scanner with a 415 mm working distance. The working distance of the scanning optics component 310 is the distance from a bottom 311 of the scanning optics component 310 to the focal point. The virtual ray measurements are made using rays 306 that extend from a ray origin 308 to points on a surface of a part within the field of view 304. Before virtually measuring the ray distance and the ray angle, the location of the ray origin 308 may be determined for the scanning optics component 310 being used. In an embodiment, the ray origin 308 may be the location that matches the ray angle of incidence at the edges 309 of the field of view 304.

Referring to FIG. 3A, the height (X) of the ray origin 308 above a bottom 311 of the scanning optics component 310 may be calculated from the working distance (WD), half the length of the field of view (Half FOV), and the average angle of incidence (A), where A=(Angle of incidence at X Edge of FOV+Angle of incidence at Y Edge of FOV)/2. The height (X) of the ray origin 308 may thus be calculated according to the following equations:

Tan(A)=Half FOV/(X+WD) (1)

X=(Half FOV/Tan(A))−WD (2)

In the illustrated example of a 2D high power scanner having a 415 mm working distance, WD=415 mm, Half FOV=100 mm, Angle of Incidence at X Edge of FOV=8.25 degrees, and Angle of Incidence at Y Edge of FOV=9.79 degrees. Using the equations above and these parameters, the height (X) of the ray origin 308 above the bottom 311 of the scanning optics component 310 is calculated to be X=215 mm for this example of the 2D high power scanner having a 415 mm working distance.

Using the calculated height (X) of the ray origin 308, the simulation software may be used to virtually measure a ray distance to a point on the surface and a ray angle at the point, for example, using the RayCast function of the Visual Components simulation software. The virtually measured ray distance may be compared to a nominal distance, which is the working distance plus the height of the ray origin (WD+X), to determine a defocus distance (z). The defocus distance (z) represents the distance between the point on the surface and the focal point of a laser beam passing through the point on the surface. A defocused beam spot size (c) at the point may be calculated using the defocus distance (z), a known beam spot size (Go) at focus, and a known beam parameter product (BPP) using the following equation:

$$σ = {σ}_{0} \sqrt{( 1 + {( BPP \frac{z}{{( {σ}_{0} / 2 )}^{2}} )}^{2}} \qquad ( 3 )$$

In one example, the RayCast function returns a vector normal to the surface at the point of incidence and the ray angle is virtually measured by calculating the ray angle from the ray and the surface normal vector (e.g., using vector math). The virtually measured ray angle may be a glancing angle (α) or may be an angle of incidence used to determine the glancing angle (α). The beam spot area for a square or round beam spot (A_{square}/A_{round}) may be calculated from the glancing angle (α) and the defocused beam spot size (σ) according to the following equations:

$${A}_{square} = \frac{{σ}^{2}}{sin ( α )} \qquad ( 4 )$$

$${A}_{round} = \frac{π}{4} \frac{{σ}^{2}}{sin ( α )} \qquad ( 5 )$$

The relative fluence may then be determined by comparing the calculated beam spot area (A) to a nominal beam spot area (Aₙ) for a normal beam focused on the surface (i.e., where the defocus distance and angle of incidence are 0). For example, the relative fluence expressed as a percentage of nominal fluence may be calculated by dividing the calculated beam spot area (A) based on the virtual measurements by the nominal beam spot area (Aₙₒₘᵢₙₐₗ) as follows:

Percentage of Nominal Fluence=A/Aₙₒₘᵢₙₐₗ*100 (6)

A pulse fluence (Fₚ) may also be calculated for the point on the surface from the pulse energy (Eₚ) for the laser and the calculated beam spot area (A) using the following equation:

$${F}_{P} = \frac{{E}_{P}}{A} \qquad ( 7 )$$

The relative fluence may also be determined by comparing the pulse fluence (Fₚ) to a nominal pulse fluence for a normal beam focused on the surface.

This process of virtually measuring ray distance and ray angle and determining a simulated fluence value may be repeated iteratively for multiple points on a surface of the part, for example, across an ablation patch being processed. In an embodiment, the simulation software may display a relative fluence determined for each of the points on the surface by displaying colors representing the relative fluence on the surface of an image of the part (e.g., generated from a CAD file). Different colors may be associated with different ranges of relative fluence (e.g., based on a percentage of nominal fluence) and the color associated with the relative fluence determined for each point may be displayed at that point on a visual representation of the surface of the part. A color scale may be applied based on user-defined thresholds, for example, such that different colors represent “acceptable,” “questionable” and “not acceptable” laser fluence. This feedback may be used to optimize the position, the path, and/or the size of the area ablated by the laser scanner.

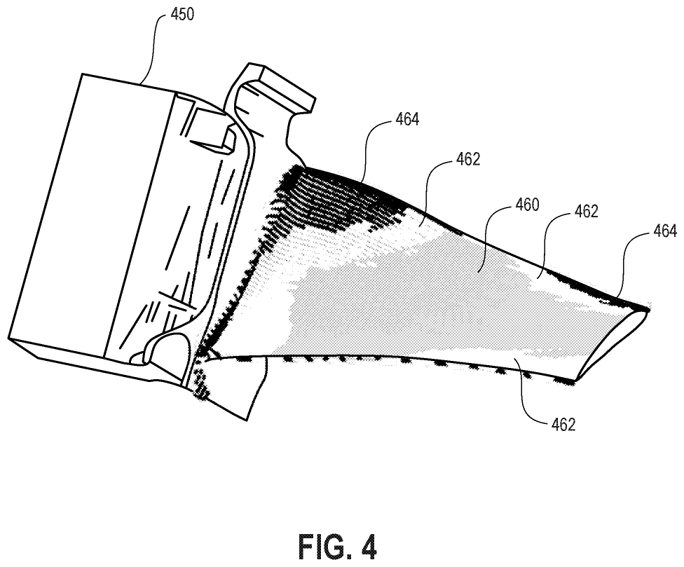

FIG. 4 is an example of a graphical user interface (GUI) displaying a graphical representation of a part 450 to be processed after performing a laser fluence simulation for a laser ablation/cleaning process, consistent with an embodiment of the present disclosure. The image of the part 450 may be generated from the CAD file and displayed, for example, on a display of the computer 228 together with the colors associated with the relative fluence determined for each of the points on the surface of the part. In the illustrated example, the part 450 to be processed is a turbine blade part and the simulation is performed with a single scanner position centered on the turbine blade. As shown, the turbine blade part 450 has an irregular shape and thus the beam spot area of a laser beam scanning the part 450 will vary as the defocus and angle of the beam change relative to the surface, as discussed above.

In the illustrated example, green represents a relative fluence in a range of 95-100% nominal fluence which is considered acceptable, yellow represents a relative fluence in a range of 85-95% nominal fluence which is considered questionable, and red represents a relative fluence less than 85% nominal fluence which is considered not acceptable. Based on this display of the laser fluence simulation, a user may determine that the laser fluence will be acceptable in the green section 460, the laser fluence will be questionable in the yellow sections 462, and the laser fluence will not be acceptable in the red sections 464. The user may thus adjust the scanning and/or process parameters to improve the laser fluence, for example, to achieve acceptable laser fluence across the entire surface of the part 450. In this example, scanning and/or process parameters may be adjusted to adjust the defocus and/or the angle of the beam in the yellow sections 462 and the red sections 464 such that the laser fluence is improved in those sections. Such adjustments may include, for example, adjusting the cleaning patch size, height and/or angle of the scanning optics component and/or adjusting a path of the laser relative to the part.

In this example, a fluence close to nominal fluence (e.g., 95-100%) is considered acceptable. In other examples, an intentional defocus may be desired and a fluence less than nominal (e.g., 85-90%) is considered acceptable, and thus, a fluence close to nominal fluence may be considered not acceptable and colored accordingly. Although three ranges or levels of relative fluence are shown in this example, any number of levels may be used and any appropriate range of percentage of nominal fluence may be assigned to any level. In addition, any color may be assigned to any level. Although red represents a lower fluence in this example of a laser ablation/cleaning process, red may represent a higher fluence in other examples, as described below.

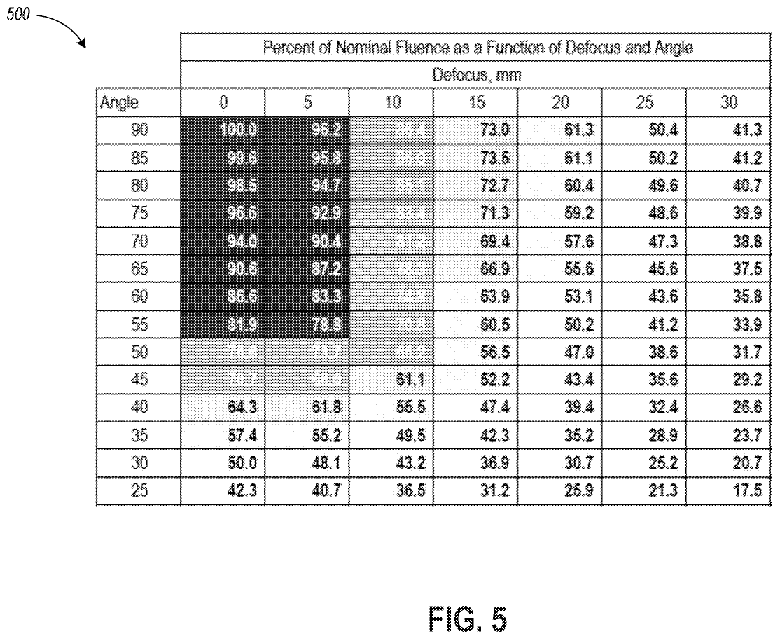

FIG. 5 shows a table 500 illustrating another example of a color scale associated with relative fluence levels, consistent with the present disclosure. In this example table 500, the relative fluence levels are shown as a percent of nominal fluence as a function of defocus and glancing angle and the colors are shown as a spectrum of colors from green to yellow to red. As discussed above, the laser fluence drops as a function of increased defocus of the laser beam and reduced glancing angle (i.e., increased angle of incidence) of the laser beam. As shown, a glancing angle of 90 degrees and defocus of 0 mm (i.e., a laser beam directed normal to the surface with the focal point at the surface) results in the nominal laser fluence (100%) and is associated with a solid green color. At the other end of the spectrum, a glancing angle of 25 degrees and a defocus of 30 mm results in a relative laser fluence of 17.5% of the nominal laser fluence and is associated with a solid red color. Over the ranges of relative fluence, the color spectrum transitions from green to yellow to red. The relative fluence thresholds associated with the different colors may be determined by a sensitivity study. The sensitivity study determines the degree of degradation where the nominal fluence becomes questionable, and where the nominal fluence becomes not acceptable. The colors may then be set according to the results of the sensitivity study in order to simulate the process accurately prior to running the process on physical parts.

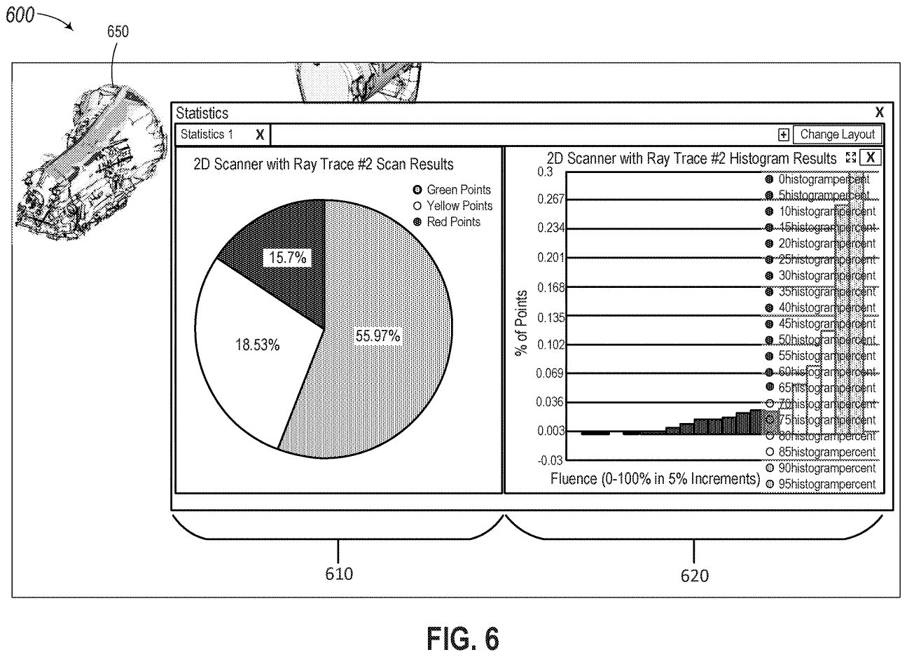

As shown in FIG. 6, the results of a laser fluence simulation may also be analyzed and displayed as a laser fluence quality report 600 to a user, for example, on the computer 228. As shown, the laser fluence quality report 600 may be displayed together with a graphical representation of a part 650 having the colors on the part 650 to show the simulated fluence values on the surface of the part. In this example, the part 650 to be processed is a vehicle transmission. The laser fluence quality report 600 may include charts summarizing the relative fluence levels on the part 650 using the associated colors. For example, a first chart 610 may be a pie chart showing the percentage of points that fall into each relative fluence range (e.g., green/acceptable, yellow/questionable, and red/not acceptable) and a second chart 620 may be a histogram that shows how the population of points is distributed across the fluence spectrum (0-100%). In this embodiment, these charts represent the predicted quality or effectiveness of the ablation/cleaning process based on the laser fluence simulation and may assist the user in determining whether the program for the ablation process meets the desired requirements or if adjustments are necessary. Other types of laser fluence quality reports and charts are also within the scope of the present disclosure.

Although the illustrated embodiments show colors associated with relative fluence calculated for each of the points, colors may also be associated with a pulse fluence calculated for each of the points and displayed on the part. In other embodiments, the simulated fluence values (fluence or relative fluence) determined for the points on the surface of the part may be further processed (e.g., by the computer 228) to determine any necessary adjustments to the ablation/cleaning process and adjusted parameters may be provided to the scanning laser processing system 200. For example, artificial intelligence may be used to analyze the simulated fluence values across the surface of the part and to determine adjusted parameters to achieve the desired fluence for the ablation/cleaning process, without requiring user assessment and interaction.

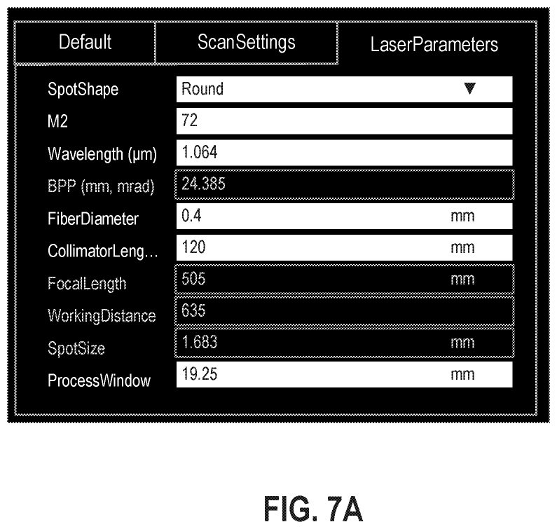

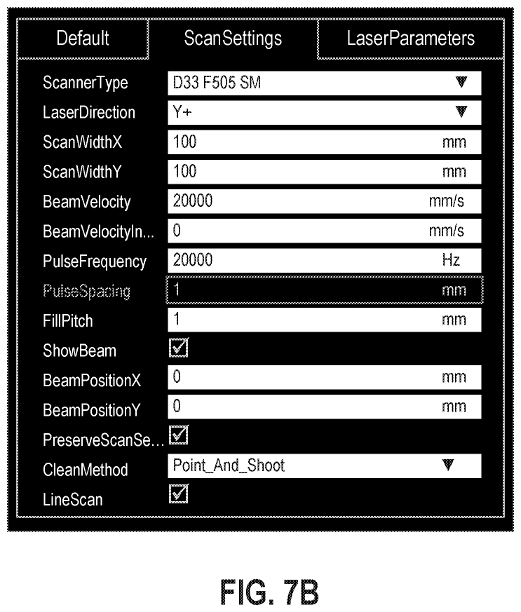

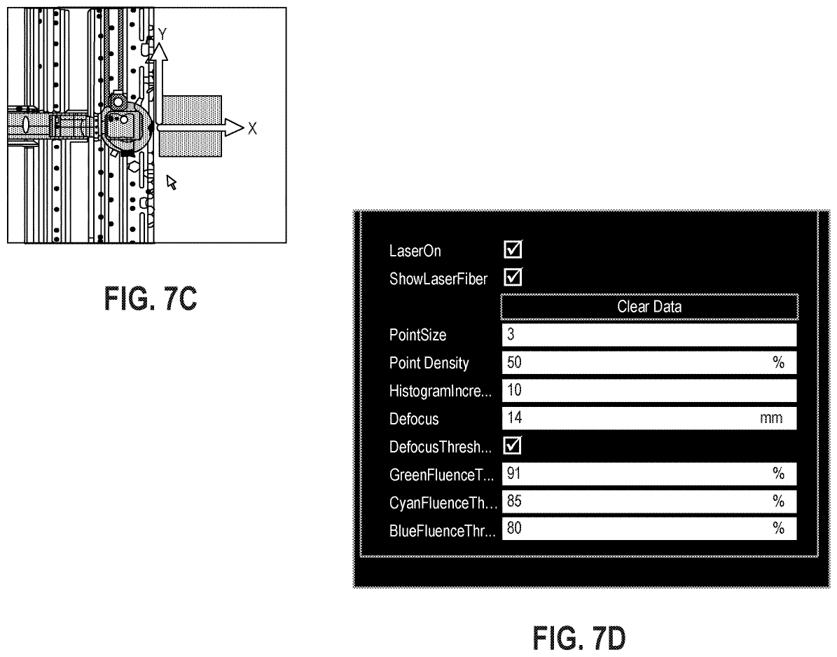

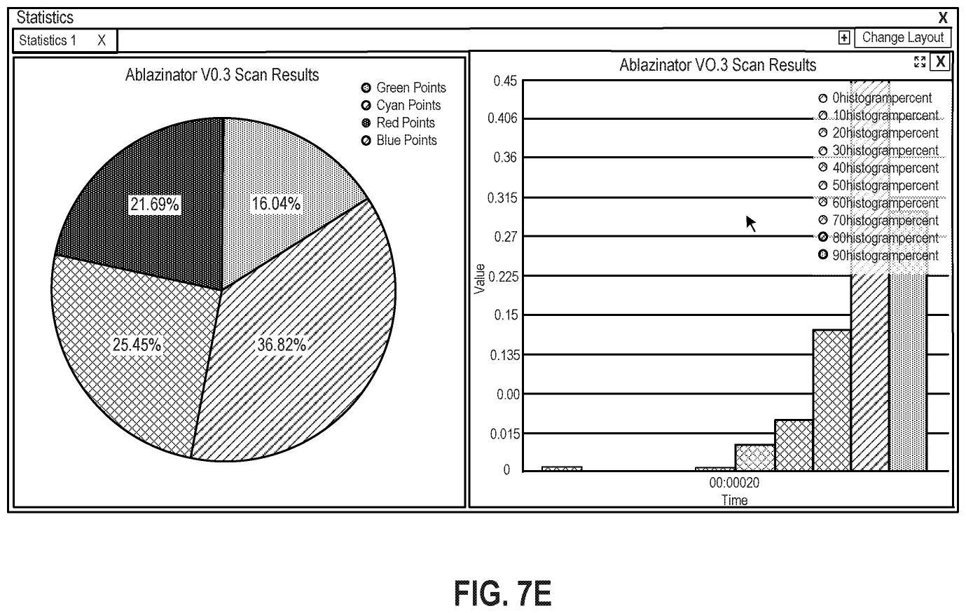

Referring to FIGS. 7A-7D, an example of the laser processing parameters and simulation parameters that may be used for a laser fluence simulation of the scanning laser processing system 200 including a 2D scanner are described in greater detail. Some of these parameters may be selected and/or entered by the user and other parameters may be programmatically calculated. User-defined parameters may be selected and/or entered using a graphical user interface (GUI) provided, for example, on the computer 228.

FIG. 7A is a screenshot of an example GUI illustrating laser processing parameters including SpotShape, M2, Wavelength, BPP, FiberDiameter, CollimatorLength, FocalLength, WorkingDistance, SpotSize, and ProcessWindow. The SpotShape parameter is the shape of the laser beam spot, which may be either round or square and is determined by the type of fiber used (i.e., round or square cross-section) in the scanning laser processing system. The M2 (“M Squared”) parameter is a laser beam parameter known as the “beam quality factor” and may be used to calculate the BPP (“Beam Parameter Product”) parameter. The Wavelength parameter is the wavelength of the laser light produced by the laser in the scanning laser processing system and may also be used to calculate the BPP parameter. The BPP parameter is the divergence angle of the laser beam multiplied by the radius of the laser beam at the narrowest point of the laser beam and may be calculated as BPP=Wavelength*M2/π. As discussed above, the BPP parameter is used to calculate spot size of the beam at some distance from the focal plane (virtually measured by the ray). The FiberDiameter parameter is the size of the fiber transmitting light from the laser source to the optics component and may include the diameter for a round fiber or the size of a square fiber. The CollimatorLength parameter is the length of a collimator in the scanning optics component and is used in calculation of the SpotSize parameter. The FocalLength parameter is the focal length of a focusing lens in the scanner. The WorkingDistance parameter is the distance from the bottom surface of the scanner to the focal plane. The SpotSize parameter is the size of the laser beam spot at the focal plane and may be calculated as SpotSize=FiberDiameter*FocalLength/CollimatorLength. The ProcessWindow parameter is the distance on both sides of the focal plane where spot size (and thus fluence) are close to nominal values and may be used to create a visible portion of crosshairs to help in programming the part.

FIG. 7B is a screenshot of an example GUI illustrating additional laser processing parameters including ScannerType, LaserDirection, ScanWidthX, ScanWidthY, Beam Velocity, Beam VelocityInitial, PulseFrequency, PulseSpacing, FillPitch, BeamPositionX, BeamPosition Y, and CleanMethod. The ScannerType parameter is the specific scanner model and may be selected from a list of options including, for example, the D20, D33 and Mid-Power scanner families available from IPG Photonics Corp. Once the scanner type is selected, the properties for that particular optic are automatically set by the program (e.g., FocalLength, WorkingDistance, Maximum Field Size). The LaserDirection parameter refers to the X and Y directions, as shown in FIG. 7C, and scanning progresses in the chosen direction (X+, X−, Y+, Y−). The LaserDirection is coordinated with the motion of the robot and typically is the same as the direction of motion. The ScanWidthX and ScanWidthY parameters are the size of the scan field in the X and Y directions, respectively, and may be up to the maximum for an optic.

The Beam Velocity parameter is the velocity at which the galvos move the beam throughout the scan field. The Beam VelocityInitial parameter is the velocity of the beam when the laser begins firing, for example, where the galvos have put the mirrors in motion so that, when the beam is turned on, the movement can be at constant velocity, instead of starting at 0 and ramping up. This initial velocity of the beam may prevent scorching the part during that ramp-up. The PulseFrequency parameter is the frequency at which the laser pulses the beam and this pulsing provided by pulsed lasers allows for precise control of the heat input to the part surface. The PulseSpacing parameter is the distance from one pulsed spot to another and PulseSpacing=Beam Velocity/PulseFrequency. The FillPitch parameter is the distance between adjacent rows of pulsed spots. The BeamPositionX and BeamPositionY parameters are the X position and Y position, respectively, of the beam within the scan field and may be used to manually set the laser beam to inspect for potential beam blockage by the part or fixturing. The CleanMethod parameter is a cleaning method setting that may be either “Point and Shoot” (scanner is static while the laser beam scans through the scan field) or “On The Fly” (scanner is moving while the laser beam scans through the scan field.

FIG. 7D is a screenshot of an example GUI illustrating simulation parameters including PointSize, PointDensity, HistogramIncrement, GreenFluenceThreshold, CyanFluenceThreshold, and BlueFluenceThreshold. The PointSize parameter is the display size of each colored point created on the 3D geometry of a graphical representation of a part. The PointDensity parameter is a setting that controls the density of the scan pattern and thus points created. The HistogramIncrement parameter is a setting that determines the number of bars in a histogram chart showing distribution of points, for example, as shown in FIG. 7E. The Defocus parameter is a distance setting that allows for intentional defocus to clean more ‘gently’ on the part surface (e.g., larger spot size, lower fluence). The scanner is moved further from the part by this distance, but some part surfaces may be in focus as the laser moves across an uneven surface, which is not desirable in this case where there an intentional defocus is used. As a result, fluence may be greater than intended and up to nominal fluence (e.g., resulting in red colored points in this example). The GreenFluenceThreshold, CyanFluenceThreshold, and BlueFluenceThreshold parameters are settings for the colors (e.g., green, cyan, blue, and red) of the points on the surface for displaying simulated relative fluence. In the illustrated example, a relative fluence above GreenFluenceThreshold will be colored red. A relative fluence between GreenFluenceThreshold and the CyanFluenceThreshold will be colored green. A relative fluence between CyanFluenceThreshold and BlueFluenceThreshold will be colored cyan. A relative fluence below BlueFluenceThreshold will be colored blue.

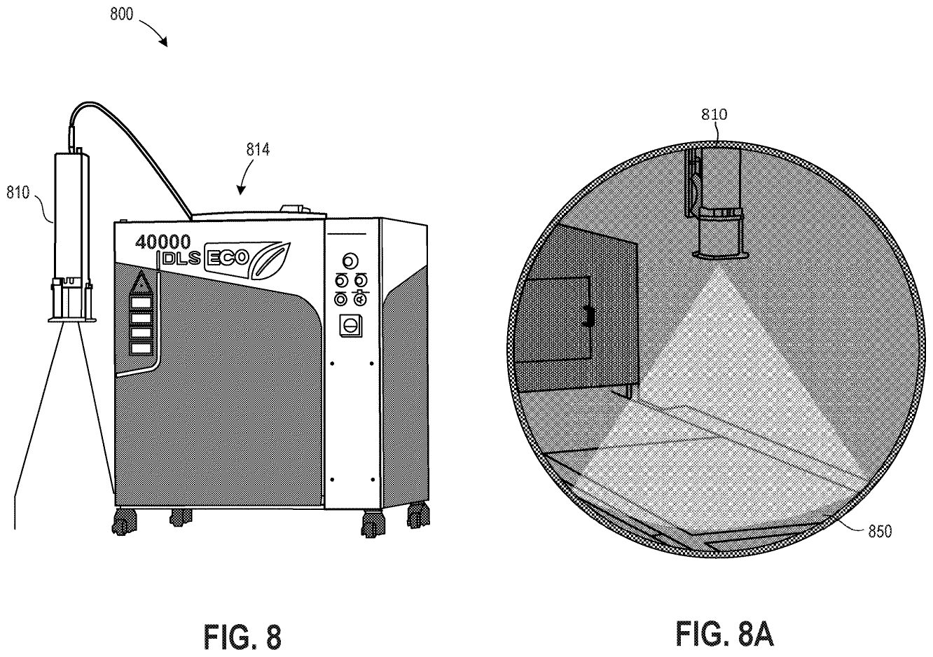

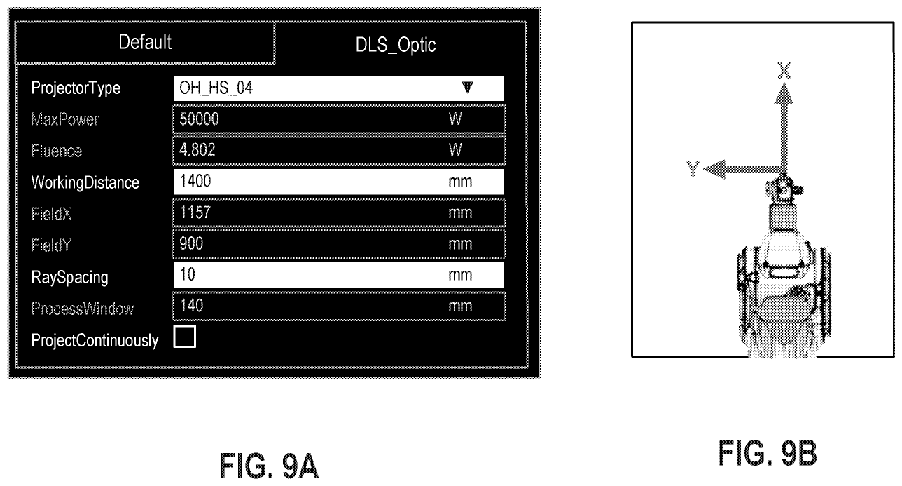

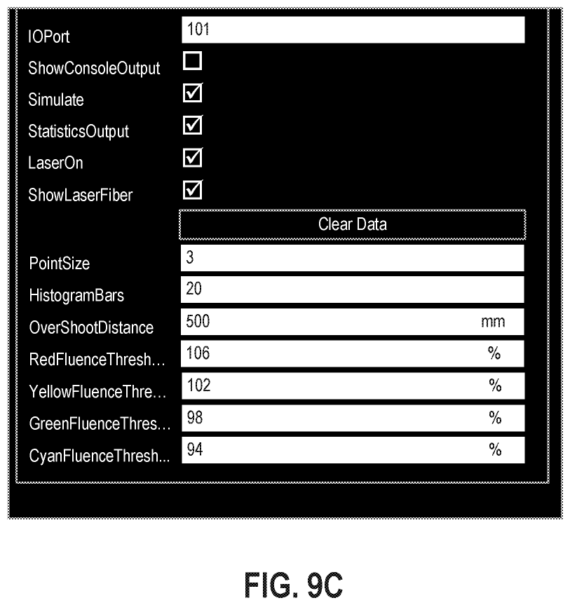

Referring to FIGS. 8-9C, an embodiment of laser fluence simulation for a projection laser processing system 800 and a heating process is described in greater detail. FIGS. 8 and 8A show one example of a projection laser processing system 800 for performing a laser treatment process, such as a heating process for drying or curing, consistent with the present disclosure. The projection laser processing system 800 includes a projection optics component 810 and a laser 814. The projection optics component 810 may be coupled to a robotic arm (not shown), for example, similar to the scanning optics component described above. The projection laser processing system 800 may also include controllers and a computer running simulation software (e.g., Visual Component simulation software), similar to the scanning laser processing system 200 described above.

The projection optics component 810 may include a projection head with a fixed optic lens that distributes laser energy evenly across a target area, such as the projection process heads available from IPG Photonics Corp., which are capable of distributing laser energy over areas as small as 25 cm² and as large as 10,000 cm². As shown in FIG. 8A, the projection optics component 810 may project a laser beam over a wide area of a surface of a part 850 and the power density of the beam is typically lower than that of a focused beam used for other laser processing applications, such as ablation/cleaning. The laser 814 may include a fiber laser such as the DLS Series of lasers available from IPG Photonics Corp.

In a projection laser processing system 800, the laser fluence is also a function of the distance the laser travels to the surface of the part and the angle of the laser relative to the surface. For example, the illumination on the surface and thus the laser fluence decrease as the distance and angle of incidence increase. When the projection laser processing system 800 is used to treat a complex surface with a varying geometry, the laser fluence varies at different locations across the surface and may vary within the field of view of the projection optics component 810. Such a variation in laser fluence on the surface of the part may result in ineffective or inconsistent heating of the part surface at certain locations. A simulation of laser fluence on the surface may be used to determine adjustments in the projection laser treatment process to optimize or provide a more effective heating of the surface.

The system and method for simulation of laser fluence on a surface of a part may be used to simulate laser fluence in the projection laser processing system 800 similar to the scanning laser processing system 200 described above. Simulation software (e.g., running on a computer coupled to the projection laser processing system 800) may receive part data, such as a CAD file, representing the part 850 to be heated for a drying or curing application. The simulation software also receives laser processing parameters defining characteristics of the projection optics component 810 and/or the laser 814, such as a working distance and fluence at the working distance. The simulation software may also receive laser processing parameters that define characteristics of the heating process, such as the size of the area to be heated. The simulation software may further receive simulation parameters that define characteristics of the laser fluence simulation, such as user-defined thresholds for different ranges of relative fluence. Examples of the laser processing parameters and simulation parameters are described in greater detail below. The simulation software may then run a simulation of the heating process on the part represented by the part data, and during the simulation, performs virtual measurements and determines simulated fluence values for multiple points on the part surface.

The simulation software performs the virtual measurements of ray distance and ray angle using rays extending to the points on the surface from a ray origin that is set relative to the projection optics component. The ray origin may be set at a location in the projection optics component that is determined in a manner similar to the scanning optics component. The simulation software may determine a simulated fluence value from the virtually measured ray distance and ray angle using the laws of illuminance, as will be described in greater detail below. The simulation software may repeat these virtual measurements and determinations for each of the points on the surface as the ray is scanned across the surface (e.g., within the area being heated by the projected laser) during the simulation. During the simulation in this embodiment, the ray is scanned through the field of view for measurement purposes one point at a time, although all of the light rays emanate simultaneously within the field of view in a physical projection laser processing system.

In this embodiment of a projection laser processing system, the simulated fluence value may be calculated using the inverse square law and the cosine law. According to the inverse square law, the illumination of a surface is inversely proportional to the square of the distance between a light source and a surface. According to the cosine law, the illumination of the surface is also proportional to the cosine of the angle of incidence (θ) between the laser beam and a line normal to the surface. Thus, the illumination and laser fluence at a point (Fₚₒᵢₙₜ) may be calculated from the ray distance (rd) and angle of incidence (θ) and using the working distance or nominal distance (WD) and nominal fluence at the working distance (Fₙₒₘᵢₙₐₗ) as follows:

Fₚₒᵢₙₜ=Fₙₒₘᵢₙₐₗ*(WD/rd)²*(Cos θ) (8)

This process of virtually measuring ray distance and ray angle and determining a simulated fluence value may be repeated iteratively for multiple points on a surface of the part, for example, across the area to be heated by the projected laser. In this embodiment of a projection laser processing system, the simulated fluence value (e.g., relative fluence) determined for each of the points on a part to be processed may be displayed to the user using colors, for example, as described above in connection with the scanning laser processing system. The user may then make any necessary adjustments to improve the laser fluence during a laser treatment process using the projection laser processing system. For example, adjustments may include moving the projection optics component closer or farther from the part, changing the angle of the projection optics component relative to the part, increasing or decreasing the time of exposure to the laser light, and moving portions of the part into or out of the laser light for periods of time.

In other embodiments, the simulated fluence values (fluence or relative fluence) determined for each of the points on the surface of the part may be further processed to determine any necessary adjustments to the heating process and adjusted parameters may be provided to the projection laser processing system 800. For example, artificial intelligence may be used to analyze the simulated fluence values across the surface of the part and to determine adjusted parameters to achieve the desired fluence for the heating process, without requiring user assessment and interaction.

Referring to FIGS. 9A-9C, an example of the laser processing parameters and simulation parameters for a laser fluence simulation of the projection laser processing system 800 including a laser projector are described in greater detail. Some of these parameters may be selected and/or entered by the user and other parameters may be programmatically determined. User-defined parameters may be selected and/or entered using a graphical user interface (GUI) provided, for example, on the computer.

FIG. 9A is a screenshot of an example GUI illustrating laser processing parameters including ProjectorType, MaxPower, Fluence, WorkingDistance, FieldX, FieldY, RaySpacing, Process Window, and ProjectContinuously. The ProjectorType parameter is the specific projector model and may be selected from a list of options. Once the projector type is selected, the properties for that particular optic are automatically set by the program (e.g., WorkingDistance, Field Size X & Y). The MaxPower parameter is the maximum laser power that can be projected through the projection optic. The Fluence parameter is the power density at the working distance, where Fluence=MaxPower/(FieldX*FieldY). The WorkingDistance parameter is the distance from the bottom surface of the projection optic to the plane of nominal Fluence. The “working volume” is centered about the WorkingDistance plane and is a rectangular prism with dimensions of FieldX, FieldY and ProcessWindow (ProcessWindow may be a certain percentage of WorkingDistance, e.g., 10% of the Working Distance in direction of light travel). The FieldX and FieldY parameters are the size of the projection field in the X and Y directions, respectively, as shown in FIG. 9B. Although there is a nominal working distance, at smaller or larger working distances, FieldX and FieldY scale and Fluence follows. The RaySpacing parameter is the distance between ray aim points at the WorkingDistance plane. The ProcessWindow parameter is a percentage of the Working Distance in the direction of light travel and is the ‘depth’ of the working volume. The ProjectContinuously parameter is a setting that allows for continuous casting of rays toward the part to continually display colored points on a part where there is relative motion between the optic and the part.

FIG. 9C is a screenshot of an example GUI illustrating simulation parameters including PointSize, HistogramBars, OverShootDistance, RedFluenceThreshold, YellowFluenceThreshold, GreenFluenceThreshold, and CyanFluenceThreshold. The PointSize parameter is the display size of each colored point created on the 3D geometry of a graphical representation of a part. The HistogramBars parameter is a setting that determines the number of bars in a histogram chart showing distribution of points. The OverShootDistance parameter is a distance in addition to the WorkingDistance that the ray travels when seeking to hit objects. The RedFluenceThreshold, YellowFluenceThreshold, GreenFluenceThreshold, and CyanFluenceThreshold parameters are settings for the colors (e.g., red, yellow, green and cyan) of the points on the surface for displaying relative fluence. In the illustrated example, a relative fluence above RedFluenceThreshold will be colored red. A relative fluence between YellowFluenceThreshold and RedFluenceThreshold will be colored yellow. A relative fluence between GreenFluenceThreshold and YellowFluence Threshold will be colored green. A relative fluence between CyanFluenceThreshold and GreenFluenceThreshold will be colored cyan. A relative fluence below CyanFluenceThreshold will be colored blue.

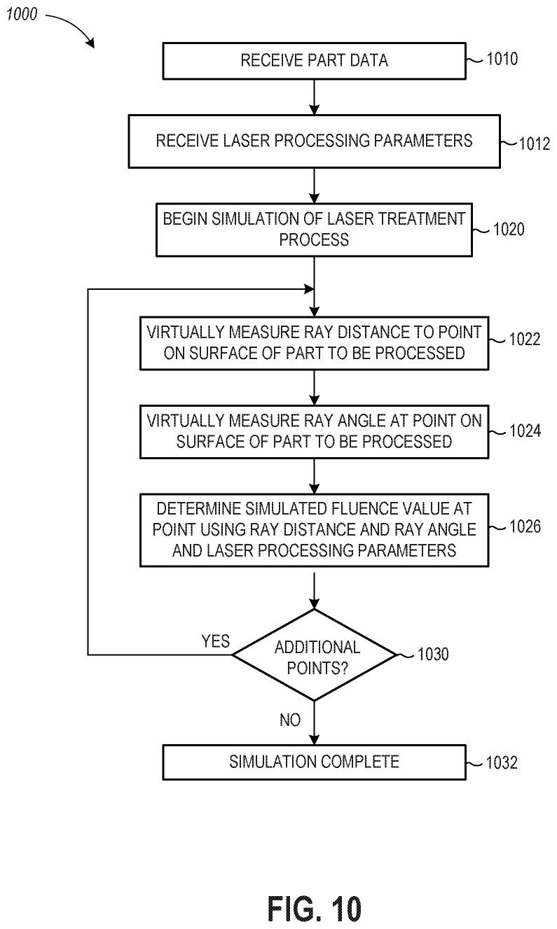

Referring to FIG. 10, a method 1000 for simulation of laser fluence on a part to be processed is illustrated and described. FIG. 10 is a flow chart diagram depicting operations for the method 1000 for simulation of laser fluence in any of the processing systems described above, consistent with embodiments of the present disclosure. As mentioned above, the method 1000 may be implemented using a computer connected to the laser processing system or a separate computer.

According to the method 1000, part data is received (operation 1010) for the part to be processed. The part data may be, for example, a Computer-Aided Design (CAD) file that may contain a 2D or 3D model of the surfaces of the part to be processed; however, any data that contains the geometry of the part to be processed may be used. Laser processing parameters are also received (operation 1012) and may include the parameters described above for use in determining the simulated fluence values. In a simulation for a scanning laser processing system, laser processing parameters may also include, for example, parameters that define the path of the laser and/or laser scanner over the part (e.g., as moved by a robotic arm) and a size of a processing area (e.g., a rectangular ablation patch).

The method 1000 then begins simulation of the laser treatment process (operation 1020) where rays are scanned across points on the surface of the part within an area being treated. During simulation of the laser treatment process, the method 1000 positions a ray at a point on the surface of the part to be processed, virtually measures a ray distance to the point on the surface (operation 1022) and virtually measures a ray angle at the point on the surface (operation 1024). The ray distance is a distance from a ray origin set relative to the optics component to the point on the surface and the ray angle is either an angle of incidence or a glancing angle of the ray relative to the surface at the point, as described above. In one example where the Visual Components simulation software is used, the RayCast function is used to virtually measure the ray distance and the ray angle at the point.

The method 1000 then determines a simulated fluence value at the point (operation 1026) using the ray distance and ray angle that were virtually measured and using laser processing parameters that were received. In a simulation for a scanning laser processing system, the simulated fluence value may be determined by determining a defocus distance and defocused beam spot size based on the ray distance compared to a nominal distance, determining a beam spot area based on the defocused beam spot size and the ray angle, and then calculating a simulated fluence value at the point based on the beam spot area, for example, as discussed above. In a simulation for a projection laser processing system, the simulated fluence value may be determined from the ray distance and ray angle using the laws of illumination, for example, as discussed above. In some embodiments, the method 1000 may also include an additional step (not shown) of displaying color associated with the simulated fluence value (e.g., relative fluence) at the point on an image or graphical representation of the part, for example, as described above. The method 1000 determines if any additional points on the surface should be simulated (operation 1030), and if yes, the operations 1022, 1024, 1026 are repeated iteratively for each point. If the method determines that no additional points on the surface should be simulated, the simulation is complete (operation 1032).

A simulation output may be displayed to the user, for example, as a 2D or 3D representation of the part to be processed including the color associated with each point and a fluence quality report, as described above. This allows the user to graphically see the effectiveness of the laser treatment process program as entered. The user can either accept the results as satisfactory or go back and adjust laser processing parameters (e.g., motion paths and/or the laser scanner parameters) and re-run the simulation. This process may be repeated as many times as necessary until the user is satisfied with the results of the laser treatment process. The laser treatment program that results in satisfactory results based on the simulation may be sent to the actual laser processing system to be used in the actual laser treatment process on the actual parts.

In another embodiment, the simulated fluence values may be further processed by a computer (e.g., using artificial intelligence) to determine adjustments to the laser processing parameters and the computer may re-run the simulation until the computer determines that the results are acceptable. In this embodiment, the simulation may be run without displaying simulation results to the user and without requiring the user to evaluate the simulation results and make the adjustments.

Accordingly, systems and methods for laser fluence simulation, consistent with the present disclosure, may improve the effectiveness of a laser treatment process on parts with a complex surface having a varying geometry.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present disclosure may be a system, a method, and/or a computer program product. The system or computer program product may include one or more non-transitory computer readable storage media having computer readable program instructions thereon for causing a processor to carry out aspects of the present disclosure.

The one or more non-transitory computer readable storage media can be any tangible device that can retain and store instructions for use by an instruction execution device. The one or more non-transitory computer readable storage media may be, for example, but is not limited to, an electronic storage device, a magnetic storage device, an optical storage device, an electromagnetic storage device, a semiconductor storage device, or any suitable combination of the foregoing. A non-transitory computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from one or more non-transitory computer readable storage media or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in one or more non-transitory computer readable storage media within the respective computing/processing device.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, Field-Programmable Gate Arrays (FPGA), or other Programmable Logic Devices (PLD) may execute the computer readable program instructions by utilizing state information of the computer readable program instructions to personalize the electronic circuitry, in order to perform aspects of the present disclosure.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A computer-implemented method for simulation of laser fluence on a part to be processed during a laser treatment process performed by a laser processing system including a laser and an optics component, the computer-implemented method comprising:
receiving, by one or more computer processors, at least part data and laser processing parameters, wherein the part data represents the part to be processed during the laser treatment process, wherein the laser processing parameters define characteristics of the laser treatment process and the laser processing system;
virtually measuring, by one or more computer processors, ray distances to a plurality of points on a surface of the part to be processed and ray angles relative to the plurality of points on the surface of the part to be processed during a simulation of the laser treatment process, wherein the ray distances and the ray angles are based on a ray origin determined relative to the optics component; and
determining, by the one or more computer processors, a simulated fluence value for each point of the plurality of points on the surface of the part to be processed, wherein the simulated fluence value is determined from the ray distance and the ray angle virtually measured for each point during the simulation of the laser treatment process and from the laser processing parameters.

2. The computer-implemented method of claim 1, wherein the simulated fluence value represents a fluence on the surface at the point.

3. The computer-implemented method of claim 1, wherein the simulated fluence value represents a relative fluence at the point as compared to a nominal fluence for the laser treatment process.

4. The computer-implemented method of claim 3, wherein the relative fluence is a percentage of the nominal fluence for the laser treatment process.

5. The computer-implemented method of claim 3, further comprising:
displaying, by the one or more computer processors, colors associated with the relative fluence determined for each point of the plurality of points on a visual representation the surface of the part to be processed, wherein different colors are associated with different ranges of relative fluence.

6. The computer-implemented method of claim 5, further comprising:
receiving simulation parameters, wherein the simulation parameters define characteristics of the simulation of laser fluence.

7. The computer-implemented method of claim 6, wherein the simulation parameters include user-defined thresholds for the different ranges of relative fluence.

8. The computer-implemented method of claim 1, further comprising:
determining, by the one or more computer processors, modified process parameters for the laser treatment process based on the simulated fluence value determined for each point of the plurality of points.

9. The computer-implemented method of claim 1, wherein the laser treatment process includes a process selected from a group consisting of heating, curing, drying, hardening, ablation, and cleaning.

10. The computer-implemented method of claim 1, wherein the part data is a Computer-Aided Design (CAD) file.

11. The computer-implemented method of claim 10, wherein the CAD file contains a model of surfaces of the part to be processed.

12. The computer-implemented method of claim 1, wherein the laser processing parameters include a type of optics component selected from a group consisting of a scanning optics component and a projection optics component.

13. The computer-implemented method of claim 1, wherein the optics component includes a scanning optics component that scans and focuses a laser beam on the surface of the part.

14. The computer-implemented method of claim 13, wherein the laser processing parameters include at least a field size of a field of view of the scanning optics component, a first angle of incidence at X edge of the field of view, a second angle of incidence at Y edge of the field of view, a beam spot shape, a beam spot size at focus, and a beam parameter product (BPP).

15. The computer-implemented method of claim 14, wherein the ray origin is determined using the field size, the first angle of incidence at X edge of the field of view, and the second angle of incidence at Y edge of the field of view.

16. The computer-implemented method of claim 13, wherein the laser processing parameters include a laser treatment parameter defining a laser treatment patch where the laser treatment process occurs on the surface of the part to be processed, and wherein the plurality of points are located within the laser treatment patch.

17. The computer-implemented method of claim 13, wherein the laser processing parameters include a laser path parameter defining a path for scanning the laser over the part to be processed during the laser treatment process.

18. The computer-implemented method of claim 13, wherein determining each of the simulated fluence values for each of the points of the plurality of points on the surface of the part to be processed further comprises:
comparing, by the one or more computer processors, the ray distances virtually measured from the ray origin for each point of the plurality of points on the surface of the part to a nominal distance to determine a defocus distance of the laser relative to the surface at each point of the plurality of points;
determining, by the one or more computer processors, a defocused beam spot size of the laser at each point of the plurality of points on the surface of the part from the defocus distance;
determining, by the one or more computer processors, a beam spot area of the laser at each point of the plurality of points on the surface of the part from the defocused beam spot size and the ray angle virtually measured at each point of the plurality of points; and
determining, by the one or more computer processors, a relative fluence from the beam spot area of the laser at each point of the plurality of points.

19. The computer-implemented method of claim 1, wherein the optics component includes a projection optics component that projects a laser beam on the surface of the part.

20. The computer-implemented method of claim 19, wherein determining each of the simulated fluence values for each of the points of the plurality of points on the surface of the part to be processed further comprises:
calculating, by the one or more computer processors, illumination for each point of the plurality of points using the ray distances and the ray angles virtually measured at each of the points; and
determining, by the one or more computer processors, a relative fluence from the illumination calculated for each point of the plurality of points.

21. A non-transitory computer readable storage medium comprising computer readable instructions which when executed by a processor, cause the processor to perform the following operations comprising:
receiving at least part data and laser processing parameters, wherein the part data represents a part to be processed during a laser treatment process using a laser processing system including a laser and an optics component, wherein the laser processing parameters define characteristics of the laser treatment process and the laser processing system;
virtually measuring ray distances to a plurality of points on a surface of the part to be processed and ray angles relative to the plurality of points on the surface of the part to be processed during a simulation of the laser treatment process, wherein the ray distances and the ray angles are based on a ray origin determined relative to the optics component; and
determining a simulated fluence value for each point of the plurality of points on the surface of the part to be processed, wherein the simulated fluence value is determined from the ray distance and the ray angle virtually measured for each point during the simulation of the laser treatment process and from the laser processing parameters.

22. The non-transitory computer readable storage medium of claim 21, wherein the simulated fluence value represents a relative fluence at the point as compared to a nominal fluence for the laser treatment process, and wherein the operations further comprise:
displaying colors associated with the relative fluence determined for each point of the plurality of points on a visual representation the surface of the part to be processed, wherein different colors are associated with different ranges of relative fluence.

23. The non-transitory computer readable storage medium of claim 21, wherein the optics component includes a scanning optics component that scans and focuses a laser beam on the surface of the part, and wherein determining each of the simulated fluence values for each of the points of the plurality of points on the surface of the part to be processed further comprises:
comparing the ray distances virtually measured from the ray origin for each point of the plurality of points on the surface of the part to a nominal distance to determine a defocus distance of the laser relative to the surface at each point of the plurality of points;
determining a defocused beam spot size of the laser at each point of the plurality of points on the surface of the part from the defocus distance;
determining a beam spot area of the laser at each point of the plurality of points on the surface of the part from the defocused beam spot size and the ray angle virtually measured at each point of the plurality of points; and
determining a relative fluence from the beam spot area of the laser at each point of the plurality of points.

24. The non-transitory computer readable storage medium of claim 21, wherein the optics component includes a projection optics component that projects a laser beam on the surface of the part, and wherein determining each of the simulated fluence values for each of the points of the plurality of points on the surface of the part to be processed further comprises:
calculating illumination for each point of the plurality of points using the ray distances and the ray angles virtually measured at each of the points; and
determining a relative fluence from the illumination calculated for each point of the plurality of points.
